(19) United States
(12) Patent Application Publication
(10) Pub. No.: US 2006/0293967 A1
(43) Pub. Date: Dec. 28, 2006

(54) Gift registry management through business contexts in a service oriented architecture

(75) Inventors: Marco A. Deluca, Toronto (CA); Victor Chan, Thornhill (CA); Daisy Tan, Toronto (CA); Danny Yuan, Scarborough (CA)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, ARMONK, NY (US)

(21) Appl. No.: 11/168,649

(22) Filed: Jun. 28, 2005

(51) Int. Cl. G06Q 30/00

(52) U.S. Cl. 705/26

(57) ABSTRACT

There is provided a method, system and apparatus for managing access to gift registry resources in a service oriented architecture (SOA) architected commerce system. In this regard, a commerce system that has been configured according to an exemplary aspect of the invention can include a gift registry including a set of gift registry resources and business context services logic coupled to authentication logic. The business context services logic can be configured to issue contexts to requesting users for interacting with the gift registry. The gift registry, in turn, can moderate access to the gift registry resources according to the contexts.

### BACKGROUND OF THE INVENTION

The present invention pertains to computers, computer software and other information technology systems and, more particularly, to such systems as adapted for commerce computing.

Commerce systems have evolved to provide virtual storefronts whose operational capabilities far exceed those of the traditional, brick and mortar store. In the brick and mortar store, each of the sales, marketing, order fulfillment, inventory, and customer service functions remain the separate responsibilities of corresponding business roles; whereas, in a well-defined commerce system, each of the sales, marketing, order fulfillment, inventory and customer service functions can be integrated in a single computing system in a highly automated fashion. Consequently, a more optimal business operation can result in which data flows between different functional subsystems seamlessly to facilitate the daily conduct of business managed by the commerce system.

As businesses and consumers become further interconnected through computer communication networks such as the global Internet and local intranets, the commerce sites and companion computing applications that integrate interactions between businesses and consumers alike can become ever more complex. Addressing the explosion of business-to-business and business-to-consumer interactions on-line, information technologists increasingly focus on architecting and implementing complete commerce site solutions to reflect the entire life cycle of a business, in lieu of integrating multiple, disparate applications that, when combined, reflect the business life cycle. Consequently, as modern commerce sites can be both large and distributed, commerce systems have been configured to deploy complete e-commerce systems in as seamless a fashion as possible.

It is now a common trend that traditional, stand-alone, commerce oriented applications are produced from one or more components that can be individually reused to create business processes for different solutions. Each of these components can expose itself as a set of services comporting with computing standards for deploying enterprise level logic that facilitate an open service oriented architecture (SOA). An SOA essentially can be defined as a collection of services. These services communicate with each other, which communication can involve either simple data passing between two or more services, or activity coordinating by two or more services.

In an SOA, a client can invoke a service within a component to perform an operation and, optionally, the client can receive a response. Invoked services generally can include business services configured to fulfill the needs of business customers, whether those customers are individual consumers or other businesses. The services can be grouped into various SOA components where each component can specialize in functions such as catalog management, shopping cart management, credit card transaction processing, sales tax computation, gift registry management and the like.

Within a commerce model, stateless transactions can be combined to form an activity in the aggregate. The context of the activity can be maintained centrally by the commands forming the basis of the commerce system implementing the commerce model. The context can include aspects of an activity, such as the parties to the activity, the resources supporting the completion of the activity, and the medium of the activity. For example, contextual data can include a store identifier, a common language identifier, or a currency type.

The use of centralized context management requires the proprietary management of contextual data outside of the scope of the components defining the commerce model. In this regard, session management can be used to store an activity across multiple requests, such that the context of the activity associated with the requestor need not be re-established on every request. Communicating with the session management portion of the commerce system, however, can require knowledge of the interface of the session management portion and can inhibit the realization of an SOA architected commerce system.

While the management of contextual data for ordinary elements of a commerce system can be challenging, the incorporation of a gift registry in a commerce model can interject additional challenges for realizing an SOA architected commerce system. First, a gift registry can be accessed from multiple different host platforms, which can range from kiosks to home computers. Second, depending upon the user accessing a gift registry, different permissions may be involved. For instance, a registrant can modify the listing of items in the gift registry and the shipping address, while a gift purchaser can only view the listing of items and purchase the items. Intermediately, a co-registrant may be permitted to modify portions of the gift registry, while some portions may not be modified by the co-registrant. A guest user can be accorded even fewer access permissions. Thus, to accommodate interactions with the gift registry by different types of users from different platforms can involve a tight coupling of code in the commerce system. Accordingly, conventional SOA architected commerce systems are ill equipped to handle the intricacies of a gift registry.

### SUMMARY OF THE INVENTION

Embodiments of the present invention address the deficiencies of the art in respect to commerce system and gift registries, and provides a novel and non-obvious method, system and apparatus for managing access to gift registry resources in an SOA architected commerce system. In this regard, a commerce system that has been configured according to an exemplary aspect of the invention can include a gift registry including a set of gift registry resources and business context services logic coupled to authentication logic. The business context services logic can be configured to issue contexts to requesting users for interacting with the gift registry. The gift registry in turn can moderate access to the gift registry resources according to the contexts.

The business context services logic can be disposed in an SOA architected commerce system. The SOA architected commerce system can include a component logic container exposing an interface to one or more accessing clients and the container can have a configuration for hosting one or more business components. The system also can include a business context engine disposed with the container and exposing an interface to the accessing clients. Finally, the system can include a business component facade disposed within the container. The facade can have a configuration for both invoking selected ones of the business components and for communicating with the business context engine.

A gift registry resource access management method can include authenticating an interacting user requesting access to a resource in a gift registry and establishing a context encapsulating a role for the interacting user in respect to the registry. Specifically, the establishing step can include establishing a context encapsulating a role selected from the group consisting of a gift giver, a co-registrant and a registrant. The established context can be assigned to the interacting user and access to the resource for the interacting user can be moderated based upon an encapsulated role in a received copy of the established context. In this regard, the moderating step can include receiving a request for access to the resource, further receiving a context associated with the request, determining a role encapsulated within the context, and limiting access to the resource based upon the role. For instance, the limiting step can include consulting a policy for the role to determine whether access to the resource is permitted.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only, and are not restrictive of the invention as claimed.

### BRIEF DESCRIPTION OF THE DRAWINGS

The accompanying drawings, which are incorporated in and constitute part of this specification, illustrate embodiments of the invention and, together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a gift registry configured to be managed utilizing business context services in an SOA architected commerce system;

FIG. 2 is a schematic illustration of the SOA architected commerce system of FIG. 1;

FIG. 3 is a block diagram illustrating a process for utilizing the business context services in the SOA architected commerce system of FIG. 2; and,

FIG. 4 is an event diagram illustrating a process for accessing gift registry resources in the SOA architected commerce system of FIG. 2.

### DETAILED DESCRIPTION OF EMBODIMENTS

Embodiments of the present invention provide a method, system and apparatus for gift registry management utilizing business contexts in an SOA architected commerce system. In accordance with embodiments of the present invention, access to the resources of a gift registry instance in the commerce system can be moderated by the context of the interactions between an interacting user and the gift registry instance. The interacting user can range from a registrant to a co-registrant to a gift giver. Regardless, upon authentication, the context can be established for the interacting user with the gift registry.

Once established, the context can be passed as a token to the gift registry whenever a request is made by the interacting user to access a resource in the gift registry. The gift registry, in turn, can inspect the token to identify the context and limit the requested access to the gift registry resource accordingly. Yet, the passing of the context as a token can obviate the need to maintain the context centrally so as to inhibit the scalability of the gift registry to handle multiple different types of interacting users. Rather, the tokenized approach to maintaining the context for an interacting user with the gift registry facilitates a seamless integration of a gift registry in an SOA architected commerce system.

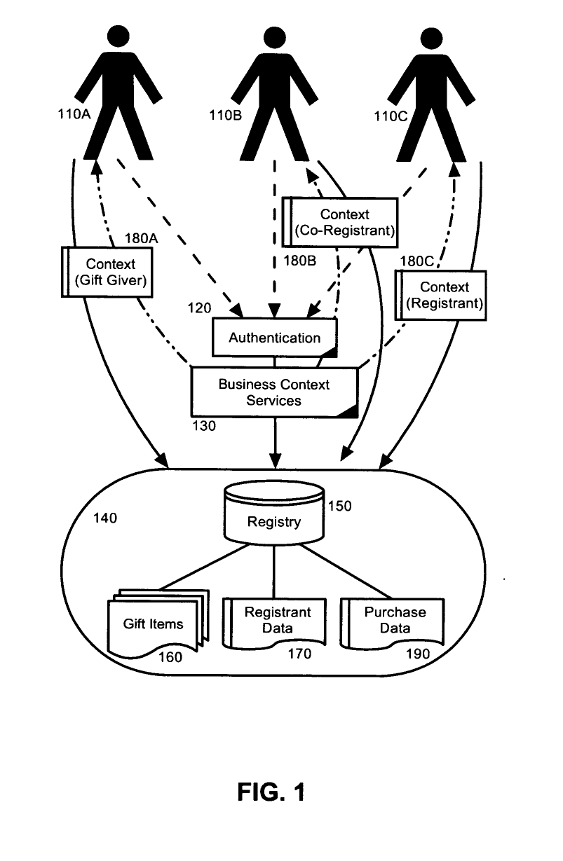

In more particular illustration, FIG. 1 is a pictorial illustration of a gift registry configured to be managed utilizing business context services in an SOA architected commerce system. As shown in FIG. 1, one or more users 110A, 110B, 110C can interact with a gift registry instance 140 having a gift registry 150 including a set of gift items 160, registrant data 170 and purchase data 190. The gift items 160 can include product and service elements available for purchase through the gift registry instance 140. The registrant data 170 can include information specific to the registrant and, optionally, one or more co-registrants for the registry 150. Examples can include shipping information, related dates and the like. Finally, the purchase data 190 can include information regarding the purchase of the gift items 160.

Prior to interacting with the gift registry instance 140, the users 110A, 110B, 110C can be authenticated through authentication logic 120. The authentication logic 120, for example, can collect user names and corresponding passwords to determine the identities and roles of the users 110A, 110B, 110C. For example, the interacting users 110A, 110B, 110C can include a gift giver 110A, a co-registrant 110B and a registrant 110C. The registrant 110C can create the gift registry instance 140 and can assign passwords associated with particular roles.

The authentication logic 120 can be coupled to business context services 130 supported within an SOA architected commerce system. The business context services 130, as part of the SOA architected commerce system, can produce and issue a context 180A, 180B, 180C for authenticating users 110A, 110B, 110C. The context 180A, 180B, 180C can vary from role to role. As shown in the exemplary configuration of FIG. 1, the context 180A, 180B, 180C can include a gift-giver context 180A, a co-registrant context 180B and a registrant context 180C.

Once the context 180A, 180B, 180C has been issued to an authenticated one of the users 110A, 110B, 110C, the individual ones of the users 110A, 110B, 110C can provide the context to the gift registry instance 140 whenever a request is made to access the gift registry 150. The gift registry instance 140, in turn, can moderate access to the gift registry 150 based upon the provided context 180A, 180B, 180C. For instance, where a gift-giver context 180A is provided, no access to the gift registry 150 can be permitted. By comparison, where a co-registrant context 180B is provided, only access to the gift items 160 can be provided. Finally, where a registrant context 180C is provided, full access can be provided to the gift items 160 and the registrant data 170.

The gift registry of the present invention can be enabled for use within an SOA architected commerce system. In the SOA architected commerce system, user credentials can be safely stored in a commerce server using a “business context service” (BCS). A gift registry context can be created and initialized when a user first accesses a gift registry instance. The context can store the gift registry accessed, and the relationship between the user and the registry, e.g., the role of the user. The context can persist for the entire user activity, such as a user session when browsing the site. Once the user authenticates to a gift registry, the user need not re-authenticate again for the duration of their session. Accordingly, it can be difficult if not impossible for a hacker to gain control of a context that does not belong to the hacker.

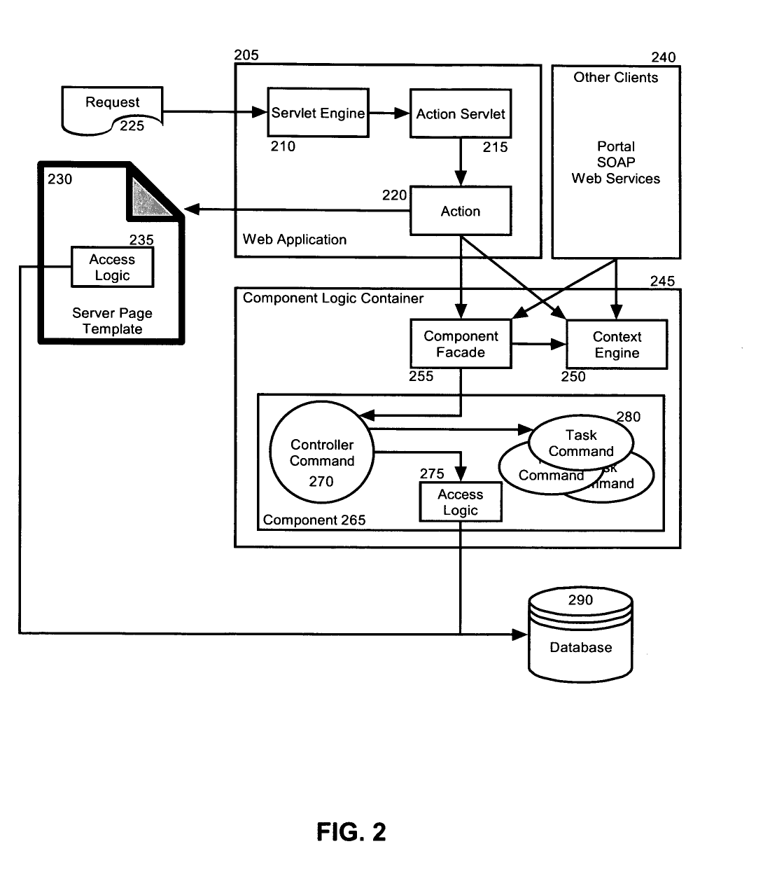

In further illustration, FIG. 2 is a schematic illustration of the SOA architected commerce system of FIG. 1. The SOA architected commerce system can include one or more service invoking client platforms including a Web application 205, as well as other clients 240 such as a portal client, simple object access protocol (SOAP) client, and a Web services client to name a few. For purposes of illustrative efficiency, only a Web application 205 is shown in detail.

The Web application 205 can be communicatively coupled to a component logic container 245 which, in turn, can be communicatively coupled to persistent storage 290. The Web application 205 can host a servlet engine 210 that can process requests 225 for commerce services through an action servlet 215. The action servlet 215, in turn, can be configured to invoke actions 220 logically linked both to a commerce application view 230 and also to a component facade 255 programmed to invoke business logic within one or more components 265 disposed with the component logic container 245.

For instance, the component facade 255 can be a component stateless session bean (SSB) logically coupled to one or more components 265 which, when combined, form a commerce system solution. Each of the components 265 can include a controller command 270 having one or more task commands 280. The controller command 270 further can be logically linked to access logic 275 configured to access persisted data in the database 290. Similarly, the commerce application view 230 can include access logic 235 likewise configured to access persisted data in the database 290.

Notably, the component facade 255 can be coupled to a business context engine 250. The business context engine 250 can manage an activity, where the activity can include a series of consecutive requests 225 from one or more service clients, in order to treat the consecutive series of requests 225 as a single conversation as between the service clients and the commerce system service defined by the components 265. The context engine 250 is responsible for managing the business contexts associated with an activity, such as the interactions of a user with a gift registry.

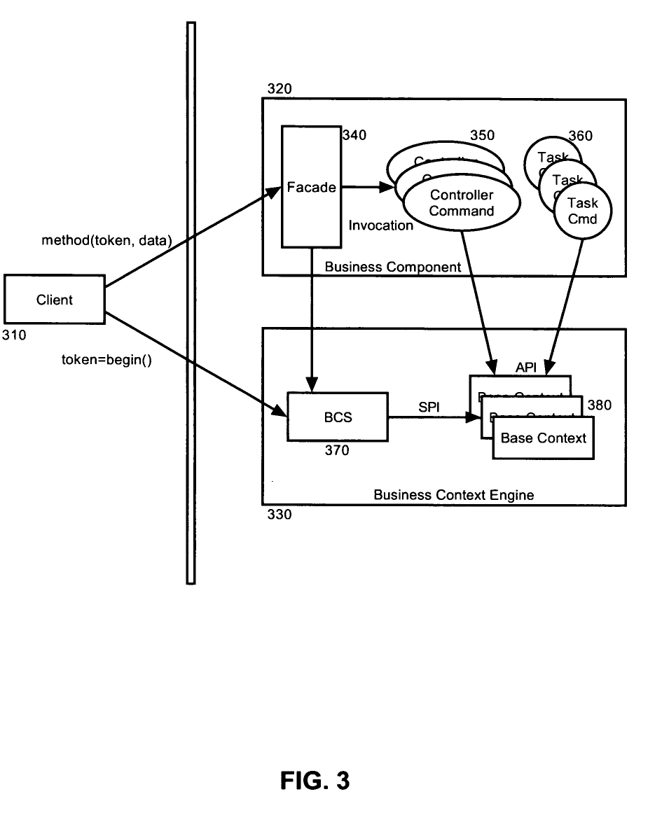

As it will be apparent from the schematic illustration of FIG. 2, the SOA of FIG. 2 can be divided into two main parts: the context engine and the component service. The context engine can provide context related services, while the component service can provide a facade to the commands and facilities to instantiate and execute a command in the commerce system. In more specific illustration, FIG. 3 is a block diagram illustrating a process for utilizing the business context services of the commerce system of FIG. 2 in the course of executing the business logic of a system component, such as a gift registry instance.

As shown in FIG. 3, a client computing process 310 can establish a communicative linkage to a business component 320, in addition to a business context engine 330. The business component 320 can include a component facade 340 through which business logic in the form of controller commands 350 and underlying task commands 360 can be invoked. The business context engine 330, in turn, can include a business context service 370 coupled to one or more business contexts 380.

In operation, the client computing process 310 can obtain an activity token from the business context engine 330, which can include a specific set of business contexts, including a gift registry context indicating a gift registry role for an interacting user operating through the client computing process 310. The client computing process 310 subsequently can pass the activity token to the business component 320 in the course of a business task in order to provide contextual information for completing the task. For instance, the business component 320 further can access elements of the business contexts 380 by way of an application programming interface (API) to the business context engine 330 utilizing the specific information of the activity token.

Specifically, to invoke a method on a business component, a client 310 or component facade 340 can obtain an activity token by first making a call to the interface of the business context service 370. In the process of obtaining the activity token, the client 310 or component facade 340 optionally can supply initialization data that can be used to populate pre-loaded contexts during creation of a new activity. Subsequently, the client 310 can pass the activity token to the component facade 340 when a particular method is invoked on the interface to the business component 320.

Notably, the activity token can be used to associate a set of contexts in effect during particular client requests to the various business components. The client can supply the activity token on every request to indicate the experience that the client would like from the business components. These contexts can include, by way of example, a solutions context indicating whether a requested operation in an activity is to be performed by a specified entity, or through an entity that acts on behalf of a specified entity. The contexts also can include a globalization context providing globalization information, an entitlement context providing information for promotional entitlement programs, a content context providing versioning information for specified content, a task context indicating a current task or state for a process having multiple tasks, and an audit context providing auditing information, to name only a few contexts.

The context of a business task can be maintained across one or more business contexts that can be incorporated into or referenced by activity tokens passed between the different business components when processing the task. Consequently, the state of each business context can be maintained across requests and transactions so that a significant performance improvement can be realized. Notably, multiple business components can operate within the same process address space such as the same virtual machine. In this circumstance, each component can share the same business context engine. Accordingly, the passing of an activity token containing or referencing the context for an activity can occur directly as between the components in the course of an intra-component call.

As shown in FIG. 3, the business context engine can be logically partitioned into a business context service and one or more business contexts. The business context service can include a service where one associates multiple unique contexts used by various components under a single identifier for a limited lifetime—the activity itself. The lifetime of an activity can span multiple requests and transactions. More specifically, the business context service is the facility that a solution controller responsible for managing the activity on behalf of the client can use to manage the set of contexts needed by the business components. The business context service also can serve as the interface that the components use to obtain the various contexts required by the components.

The business contexts, in turn, provide the data and services required by the components. Specifically, business contexts can have the following characteristics:

A context can establish an execution environment that affects the output of a business component for equivalent input based upon the solution requirements.

The output produced by a business component for a given input can be identical for the same set of contexts.

Contexts need not be directly invoked by clients of the business processes. Instead, the business component can use the services provided by the contexts during the execution of a request.

A context provides a set of service methods and optionally can provide data.

The lifespan of a context starts with the creation of an activity and ends with the completion of the activity.

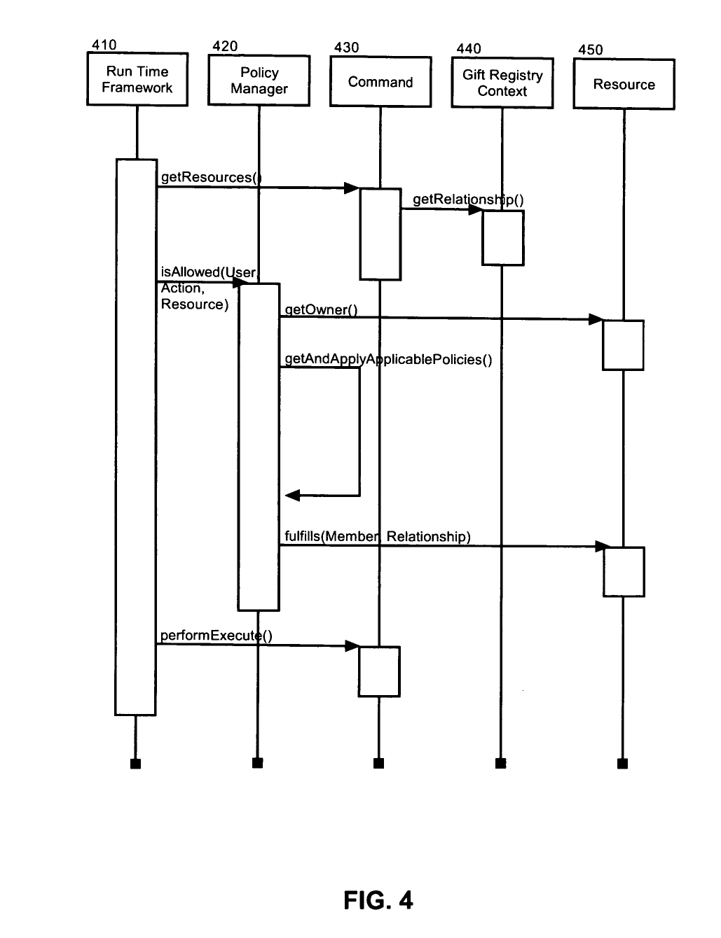

The gift registry context can be an instance of a business context. In this regard, the gift registry context can store the role or relationship of an interacting user with a gift registry instance. Based upon the role assigned to the interacting user, access to the resources of the gift registry can be moderated in a manner consistent with a policy defined for the role. In more specific illustration, FIG. 4 is an event diagram illustrating a process for accessing gift registry resources according to a role defined within a context in the SOA architected commerce system of FIG. 2.

To allow only users having proper roles or relationships to access the resources of the gift registry, access to the resources of the underlying gift registry logic can be limited to the commands of the SOA architected commerce system. When a protected resource is requested, the getResources( ) method in the command 430 can be invoked by the access controller manager in the runtime framework 410. The getResources( ) method can return a vector of logical components that are to be accessed. The command 430 can query the gift registry context 440 to identify the relationship or role of the requestor in respect to the requested resource 450.

Subsequently, the access control manager in the runtime framework 410 can invoke a policy check in the policy manager 420 to determine whether the requested action upon the requested resource is permitted in view of the identified relationship or role of the requestor. The policy manager 420, in turn, can identify the owner of the requested resource 450 in order to apply the policy. Finally, the policy manager 420 can determine if the relationship is permitted to obtain the requested level of access to the resource 450. If so, the access control manager in the runtime framework can be permitted to execute the requested resource 450 by invoking the corresponding command 430. In this way the underlying resource 450 can be shielded from direct access through the runtime framework 410.

It will be apparent to the skilled artisan that the gift registry of the present invention is scalable and can be integrated readily into an SOA architected commerce system due to the utilization of business contexts to define the role or relation of an interacting user requesting access to the resources of the gift registry. As the business contexts can persist for the duration of an activity, it is not necessary to engage in the centralized management of the context of interactions between users and the gift registry. Thus, the gift registry of the present invention can accommodate interactions by different types of users from different platforms without requiring a tight coupling of code in the commerce system.

Embodiments of the present invention can be realized in hardware, software or a combination of hardware and software. An implementation of the method and system of the present invention can be realized in a centralized fashion in one computer system or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. Embodiments of the present invention can also be embedded in a computer program product, on a computer usable medium that comprises all the features enabling the implementation of the methods described herein and which, when loaded in a computer system, is able to carry out these methods. Examples of computer usable media include recordable-type media such a floppy disc, a hard disk drive, a RAM, and CD-ROMs and transmission-type media such as digital and analog communications links.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A commerce system for gift registry resource management, the commerce system comprising:
a gift registry comprising a set of gift registry resources; and,
business context services logic coupled to authentication logic and configured to issue contexts to requesting users for interacting with said gift registry, said gift registry moderating access to said gift registry resources according to said contexts.

2. The commerce system of claim 1, wherein said gift registry resources comprise gift items and registrant data.

3. The commerce system of claim 1, wherein said contexts comprise roles for said requesting users in respect to said gift registry.

4. The commerce system of claim 3, wherein said roles comprise roles selected from the group consisting of a gift giver, a co-registrant and a registrant.

5. The commerce system of claim 1, wherein said business context services logic is disposed in a service oriented architecture (SOA) architected commerce system.

6. The commerce system of claim 5, wherein said SOA architected commerce system comprises:
a component logic container exposing an interface to a plurality of accessing clients and having a configuration for hosting a plurality of business components;
a business context engine disposed with said container and exposing an interface to said accessing clients; and,
a business component facade disposed within said container and having a configuration for both invoking selected ones of said business components and for communicating with said business context engine.

7. The commerce system of claim 6, wherein said business context engine comprises:
a business context service; and,
a plurality of business contexts accessible by said business context service.

8. The commerce system of claim 6, wherein said accessing clients comprises one of an application server hosted servlet and a Web services client.

9. The commerce system of claim 6, wherein each of said business components comprises a controller command coupled to at least one task command, and access logic configured to retrieve data from persistent storage.

10. The commerce system of claim 7, wherein said component facade comprises a stateless session bean configured for communicative coupling both to said business components and also to said business context service.

11. A gift registry resource access management method comprising the steps of:
authenticating an interacting user requesting access to a resource in a gift registry;
establishing a context having an encapsulated role for the interacting user in respect to the gift registry;
assigning the context to the interacting user; and,
moderating access to the resource for the interacting user based upon the encapsulated role in a received copy of the context.

12. The method of claim 11, wherein the step of establishing a context having an encapsulated role is selected from the group consisting of a gift giver, a co-registrant and a registrant.

13. The method of claim 11, wherein the step of moderating further comprises the steps of:
receiving a request for access to the resource;
further receiving the context associated with the request;
determining the encapsulated role within the context; and,
limiting access to the resource based upon the encapsulated role.

14. The method of claim 13, wherein the step of limiting further comprises the step of consulting a policy for the encapsulated role to determine whether access to the resource is permitted.

15. A machine usable medium having stored thereon a computer program for gift registry resource access management, the computer program comprising a set of instructions that, when executed by a machine, causes the machine to perform the steps of:
authenticating an interacting user requesting access to a resource in a gift registry;
establishing a context having an encapsulated role for the interacting user in respect to the gift registry;
assigning the context to the interacting user; and,
moderating access to the resource for the interacting user based upon the encapsulated role in a received copy of the context.

16. The machine usable medium of claim 15, wherein the step of establishing a context having an encapsulated role is selected from the group consisting of a gift giver, a co-registrant and a registrant.

17. The machine usable medium of claim 15, wherein the step of moderating further comprises the steps of:
receiving a request for access to the resource;
further receiving the context associated with the request;
determining the encapsulated role within the context; and,
limiting access to the resource based upon the encapsulated role.

18. The machine usable medium of claim 17, wherein the step of limiting further comprises the step of consulting a policy for the role to determine whether access to the resource is permitted.
